(19) United States
(12) Patent Application Publication
(10) Pub. No.: US 2013/0159210 A1
(43) Pub. Date: Jun. 20, 2013

(54) CORPORATE DEBT OPTIONS EXCHANGE

(71) Applicant: Daniel R. CARRIGAN, Moorestown, NJ (US)

(72) Inventor: Daniel R. CARRIGAN, Moorestown, NJ (US)

(73) Assignee: THE NASDAQ OMX GROUP, INC., New York, NY (US)

(21) Appl. No.: 13/326,504

(22) Filed: Dec. 15, 2011

(51) Int. Cl. G06Q 40/04

(52) U.S. Cl. 705/36 R

(57) ABSTRACT

A method, apparatus, and system are provided for matching orders for corporate debt options in a corporate debt options exchange. A corporate debt options exchange receives an order for a corporate debt option, determines one or more conditions for purchase/sale on the order for the corporate debt option, and matches the order for the corporate debt option with a stored order in an order book in the corporate debt options exchange based on the one or more determined conditions. The order is stored in the order book when no match for the order is found.

### BACKGROUND

Systems for electronically managing and exchanging (e.g., buying, selling, trading, hedging, etc.) securities and/or stocks provide users with a simple, fast, and efficient ways to manage and exchange such instruments. Currently, electronic systems allow for individuals to buy, sell, or trade stocks and/or bonds via an electronic user interface or through a broker that can also use an electronic user interface. For example, when a user submits a bid to buy a particular stock at a given price, an order for the stock is submitted to a bid matching system which then attempts to match the bid with an offer in an order book. Upon finding a match, the transaction is completed. That is, the seller of the stock receives payment for the stock, and the buyer of the stock acquires the shares of the stock purchased at the matching price.

Corporate debt securities, such as corporate bonds, are normally issued by corporations to raise money in order to expand the corporation's business. Like stocks, bonds are securities, but a major difference between a stock and a bond is that a stockholder has an equity stake in the company (i.e., an owner) where a bondholder has a creditor stake in the company (i.e., a lender).

Trading corporate bonds can be a profitable venture for an individual and/or a business. But sometimes trading the bonds themselves can be a risky venture. In order to hedge against such risk, investors can instead buy/sell options on the corporate bonds. As explained in more detail below, an option on a corporate debt security (e.g., a corporate bond) allows an investor to hedge an investment by purchasing the right to buy/sell the security at a certain price on or before an expiration date of the option.

### SUMMARY

A corporate debt option exchange apparatus comprises a memory that stores orders for corporate debt options in an order book, and one or more processors, coupled to the memory, that match orders for corporate debt options. The one or more processors receive an order for a corporate debt option, determine one or more conditions for purchase/sale on the order for the corporate debt option, and match the order for the corporate debt option with a stored order in an order book. The order is matched based on the one or more determined conditions. When no match for the order is found, the order is stored in the order book.

Another aspect provides a method for matching orders for corporate debt options in a corporate debt options exchange. An order for a corporate debt option is received, and one or more conditions for purchase/sale on the order for the corporate debt option are determined. The order for the corporate debt option is matched with a stored order in an order book in the corporate debt options exchange based on the one or more determined conditions. When no match for the order is found, the order is stored in the order book.

A non-transitory, computer-readable storage medium is disclosed having computer-readable code embodied therein and capable of being stored in a memory as computer program instructions, which when executed by a computer having one or more processors, performs the corporate debt options exchange method described in the preceding paragraph.

Another aspect relates to a corporate debt options exchange system having a broker apparatus and a corporate debt options exchange apparatus. The broker apparatus comprises one or more processors that create orders. The one or more processors are coupled to a memory that stores the created orders. The broker apparatus also has a first data transceiver device for transmitting the created orders. The corporate debt options exchange apparatus comprises a second data transceiver device that receives the created orders, a memory that stores orders for corporate debt options in an order book, and one or more processors that are coupled to the memory and match orders for corporate debt options. The one or more processors in the corporate debt options exchange apparatus receive an order for a corporate debt option, determine one or more conditions for purchase/sale on the order for the corporate debt option, and match the order for the corporate debt option with a stored order in the order book based on the one or more determined conditions. When no match for the order is found, the order is stored in the order book.

In a non-limiting, example implementation the corporate debt option is an option on the corporate debt security which allows the corporate debt security to be purchased/sold at a predetermined price on or before a predetermined expiration date.

In another non-limiting, example implementation the corporate debt options exchange is a centralized, automated electronic exchange in a corporate debt options exchange system.

In yet another non-limiting, example implementation, the one or more conditions for the order for the corporate debt option comprises selecting an amount of corporate debt options to purchase/sell, selecting a price to purchase/sell each option on the corporate debt security, selecting an expiration date for each corporate debt option, selecting a put option for the corporate debt option, selecting a call option for the corporate debt option, and/or selecting a combination of two or more put and/or call combinations.

In another non-limiting, example implementation, the order is a quote for a corporate debt option.

In yet another non-limiting, example implementation, selecting the put option allows a buyer of the option on the corporate debt security to require a seller of the option to buy the corporate debt security if exercised on any trading date before the expiration date (“American Style Exercise”) or on the expiration date (“European Style Exercise”).

In another non-limiting, example implementation, selecting the call option allows a buyer of the option on the corporate debt security to require a seller of the option to sell the corporate debt security if exercised on any trading date before the expiration date (“American Style Exercise”) or on the expiration date (“European Style Exercise”).

In yet another non-limiting, example implementation, the corporate debt option is an option on a corporate bond or an option on a corporate note.

### BRIEF DESCRIPTION OF THE DRAWINGS

FIG. 1 is a diagram of an example embodiment of a system utilizing an exchange for trading options on corporate debt securities;

FIG. 2 is a block diagram of an example embodiment of the corporate debt options exchange;

FIG. 3 is a block diagram of the corporate debt options exchange;

FIG. 4A shows an example data structure of an order for a corporate debt option;

FIG. 4B shows an example of entries in an order book for corporate debt options;

FIG. 5A shows a flowchart of an example operation for the corporate debt options exchange; and

FIG. 5B shows an example application flowchart of the corporate debt options exchange after order submission.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on non-transitory computer-readable storage medium and when the instructions are executed by a computer or other suitable processor control, the computer or processor performs the functions. Although databases may be depicted as tables below, other formats (including relational databases, object-based models and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process is a description of an apparatus for performing the process. The apparatus that performs the process may include, e.g., a processor and those input devices and output devices that are appropriate to perform the process.

Various forms of computer readable media may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

An option on corporate debt security is a corporate debt option. The term “corporate debt security” includes a bond or other evidence of indebtedness that is a direct obligation of any corporate entity, including, but not limited to any corporation, partnership, limited liability company, or limited liability partnership. Corporate debt security can also be either a TRACE-eligible security or a security listed on or traded through the facilities of a national securities exchange. In the United States, such a national securities exchange must be registered under Section 6 of the Exchange Act, and may, pursuant to registration and exchange rules, list corporate debt options. The term “TRACE” (Trade Reporting and Compliance Engine) refers to the reporting vehicle of the Financial Industry Regulatory Authority (“FINRA”) for over-the-counter secondary market transactions in eligible fixed income securities. The term “TRACE-eligible security” refers to any corporate debt security that is required to be reported to TRACE.

The ability to trade options overlying corporate debt securities in a transparent, centralized, electronic exchange serves an important economic function. In particular, the centralized exchange allows a wide range of investors and traders that may be sensitive to, among other things, the potential risk of alternative underlying securities and interest rate changes to hedge the investments. Through the use of various option purchasing, writing (selling), and combination strategies, investors and traders can use options on corporate debt securities (1) as short and long-term investment vehicles; (2) as viable alternatives to potentially more risky derivative vehicles; and (3) as a hedge against equity, option, or other security positions or against the risks associated with inverse interest rate movements (while retaining the opportunity to profit from favorable movements).

Currently, trading for options on corporate debt securities takes place in decentralized, over-the-counter markets. But, there is no system that allows users to easily submit a bid for an option on a corporate debt security in a centralized, automated electronic exchange to match with a corresponding offer.

Thus, there is a need for a centralized, electronic exchange that allows individuals, brokers, and/or businesses to conduct transactions relating to options on corporate debt securities in a seamless and efficient manner.

Providing a centralized, computer-based, automated exchange for trading corporate debt options offers several distinct benefits. First, options on corporate debt securities can be traded in a highly regulated and transparent exchange environment. Second, in conjunction with trading corporate debt options on the centralized exchange, the standardization of option contract terms and quoting and market making requirements promote more liquid and deeper markets. Third, counterparty credit risk is mitigated because the exchange interacts with the OCC, which issues and guarantees the corporate debt option contracts. And fourth, markets are more transparent because the exchange interacts with the Options Price Reporting Authority (“OPRA”), which processes quotation and last-sale data for the exchange and other OPRA members. By listing such options on a centralized, computer-based exchange, the universe of listed products available to market participants for trading and hedging purposes is expanded.

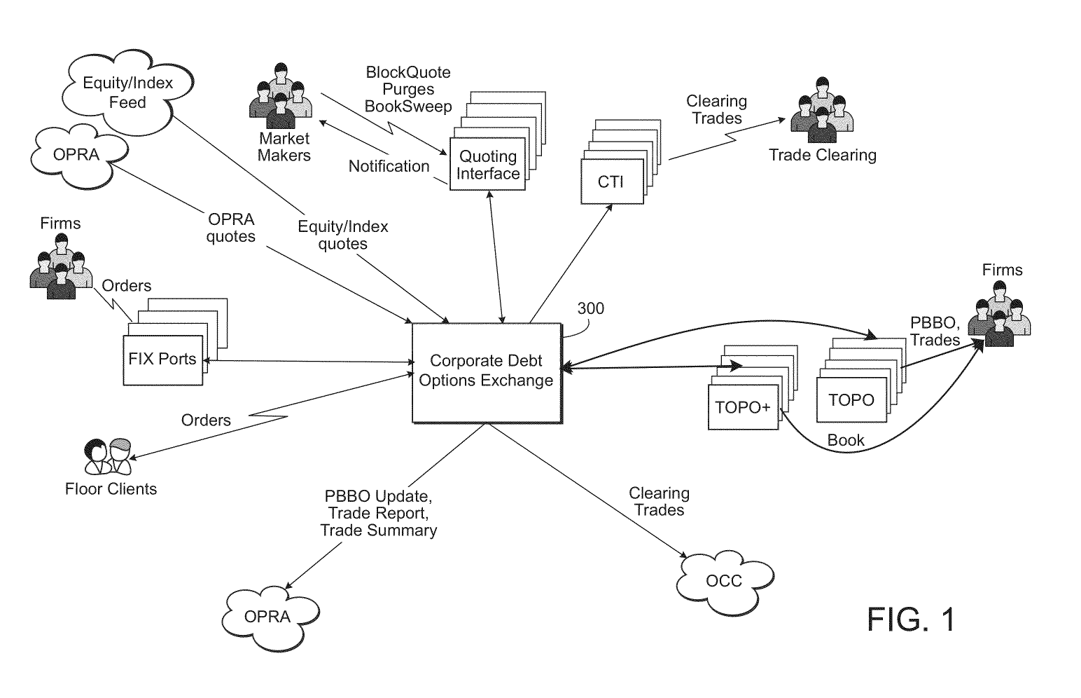

FIG. 1 shows a diagram of an example embodiment of a computer-implemented, centralized exchange for options on corporate debt securities. It should be appreciated that the corporate debt options exchange deals with the matching of orders/quotes for options on corporate debt securities, such as bonds or notes. A corporate debt security, such as a bond, is a formal contract to repay borrowed money with interest at fixed intervals. So a corporate debt security operates more like a loan, and is a non-equity interest in the corporation. The corporate debt options exchange discussed herein centralizes the trading for options on corporate debt securities and gives traders a common marketplace in which to trade the corporate debt options.

An investor and/or broker enter a trading symbol of a corporate debt security into a website and/or electronic trading interface. The investor/broker receives options data which present, for example, all Put/Call options, strike prices, and/or expiration dates available for trading with actionable bid/ask quotes of the corporate debt options. The investor/broker can then choose a specific corporate debt option put/call, strike price, expiration date, and/or a combination of two or more put and/or call values. A put option allows a buyer of the option on the corporate debt security to require a seller of the option to buy the corporate debt security on any trading date before the expiration date (“American Style Exercise”) or on the expiration date (“European Style Exercise”). A call option allows a buyer of the option on the corporate debt security to require a seller of the option to sell the corporate debt security via American Style Exercise or European Style Exercise.

Upon entering the corporate debt option bid/ask order, the order is relayed to the corporate debt options exchange using a suitable communication interface. One non-limiting, example of a communication interface is Financial Interchange Exchange (FIX) Ports. Once received at the corporate debt options exchange, attempt is made to match with other available orders/quotes. If no match is found, the order is stored in an order book at the corporate debt options exchange. Trading firms and other entities can see a display of the order book via an interface such as Top of Order Book (TOPO/TOPO+).

The corporate debt options exchange can send matched trades to both “sides” of the trade (e.g., buyers/sellers). The corporate debt options exchange can also send matched trades for clearing to the Options Clearing Corporation (OCC) and/or to a corporate debt options exchange back office, or Clearing Trade Interface (CTI), for data retention. Trade reports and trade summaries can also be sent from the corporate debt options exchange to a national reporting system, such as the Options Price Reporting Authority (OPRA). Also, the corporate debt options exchange can interact with a quoting interface for handling quotes.

An example of an investor trading corporate debt options is illustrated below. An investor may wish to purchase $10,000 face value of CISCO Corporate Debt which matures on Jan. 15, 2020 and carries a coupon rate of interest of 4.45% (“CSCO Note”). If the face value or price of the CSCO Note is $100.00, outright purchase of the Note would cost the investor $10,000. Instead of spending $10,000, the investor can replicate the investment by purchasing a call option to buy $10,000 face value. The purchase price of the call option or “premium” may be $5.00 per $100 face value resulting in a total cost of $500 for the option. That way, the investor replicates the investment by leaving open the option to buy (in case the CSCO Note goes up in price) while leaving the option to pass on the Note (in case the CSCO Note goes down in price). In the best case scenario, the Note increases in price and the investor exercises the call option at the original $100 strike price. In the worst case scenario, the Note decreases in price and the investor passes on buying the Note and only loses $500 on the call option.

As discussed above, investors can buy/sell put options and/or call options on corporate debt securities. Normally, an investor buys a call option on a corporate debt security if the investor believes that the interest rates will fall (meaning corporate debt prices will rise). Likewise, an investor buys a put option on a corporate debt security if the investor believes that the interest rates will rise (meaning corporate debt prices will fall). It should be appreciated that one result in purchasing or selling options on corporate debt securities is that the “strike price” of the underlying security is “locked in” for the term of the contract (i.e. the term of the option), thereby reducing the credit risk associated with fluctuations in the price of the security. By providing a centralized, computer based, automated exchange a large number of investors can buy/sell the corporate debt options in a transparent marketplace in a fast and efficient manner.

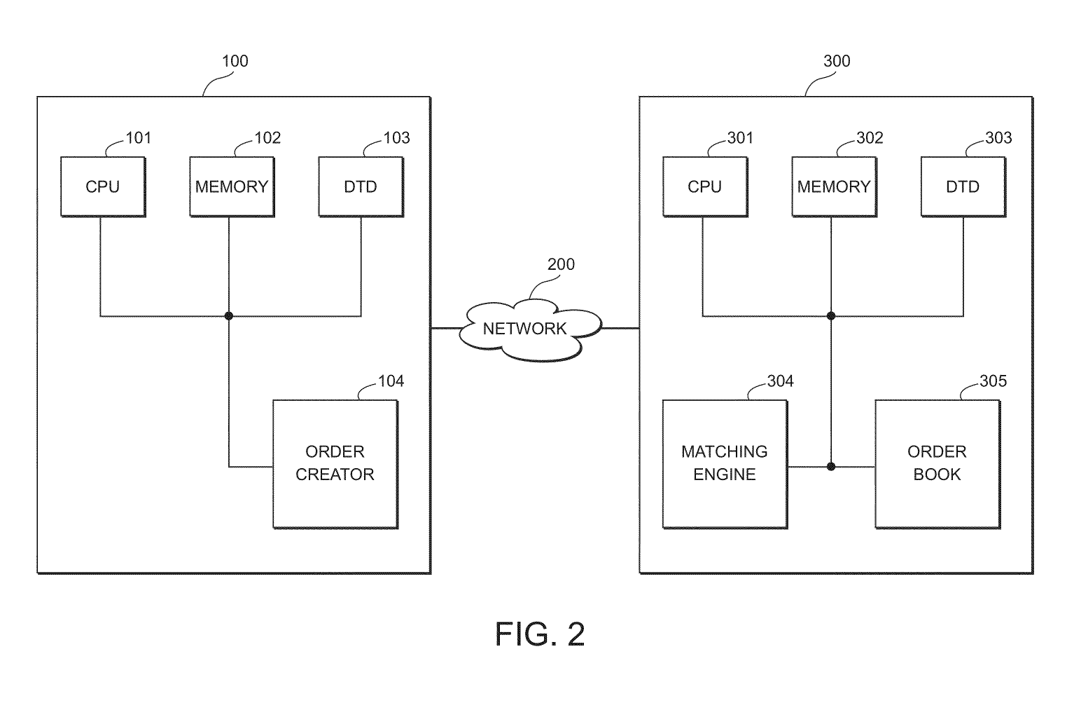

FIG. 2 shows a function block diagram of an example embodiment of the corporate debt options exchange 300 coupled via a network 200 to a broker system 100 configured to create and place orders with the corporate debt options exchange 300. The broker system 100 can be implemented with and/or used via a personal computer, a PDA device, a cell phone, a server computer, or any other system/device for conducting the electronic exchange described herein. It should also be appreciate that the broker system 100 is not limited to a broker but can be any individual and/or business conducting electronic exchange of corporate debt securities and/or options on corporate debt securities. It should also be appreciated that the corporate debt options exchange 300 communicates with a plurality of broker systems 100 to match orders.

The broker system 100 includes a central processing unit (CPU) 101, a memory 102, and a data transmission device 103. The data transmission device (DTD) 103 can be, for example, a network interface device that can connect the broker system 100 to the network 200. A common communication interface protocol is the FIX protocol, discussed above. The connection can be wired, optical, or wireless and can connect over a Wi-Fi network, the Internet, or a cellular data service, for example. The data transmission device 103 can also be an input/output device that allows the broker system 100 to place the data on a computer-readable storage medium. It should be appreciated that the data transmission device 103 is capable of sending and receiving data (i.e. a transceiver).

The broker system 100 can be used for conducting exchange of options on corporate debt securities with the corporate debt options exchange 300. The broker system 100 can take an order from a user for an option on a corporate debt security. For example, a user may wish to purchase a put option on $10,000 face value of IBM bonds for $5.00 per $100 face value. The user can enter the order in the broker system 100 by placing an order request to buy the put option using the order creator 104. Upon finishing the order, the order creator 104 transmits the order over the network 200 using the data transmission device 103. The corporate debt options exchange 300 then receives the order for processing.

The corporate debt options exchange 300 includes a CPU 301, a memory 302, and a data transmission device 303. In a preferred example embodiment, the corporate debt options exchange 300 may include multiple processors and/or memories and may be designed for fail-safe redundancy. The data transmission device (DTD) 303 can be, for example, a network interface device that can connect the exchange 300 to the network 200. It should be appreciated that the data transmission device 303 is capable of sending and receiving data (i.e. a transceiver).

The corporate debt options exchange 300 also has a matching engine 304, implemented using one or more processors, for matching orders for options on corporate debt securities and an order book memory 305 for storing orders. It should be appreciated that the order book 305 can exist in the memory 302 of the corporate debt options exchange 300.

As discussed above, the corporate debt options exchange 300 can receive an order placed from the broker system 100 via, for example, the network 200. Upon receiving an order, the matching engine 304 attempts to match an order with a corresponding order in the order book 305. Using the example above, the exchange 300 attempts to find an order in the order book for selling a put option on $10,000 face value of IBM bonds for $5.00 per $100 face value. Upon matching the order, the exchange 300 sends an electronic message to the broker system 100 via the data transmission device 303 to notify the user that the order was successfully matched.

In an example embodiment, if the order does not successfully match, the exchange 300 can store the order in the order book 305. It should also be appreciated that the exchange 300 can partially match orders in the order book 305. That is, the matching engine 304 may find an order that does not fully match an order for a put option on $5,000 face value of IBM bonds for $5.00 per $100 face value, but can partially match the order. In that event, the partial match executes and the remainder of the order is stored in the order book 305.

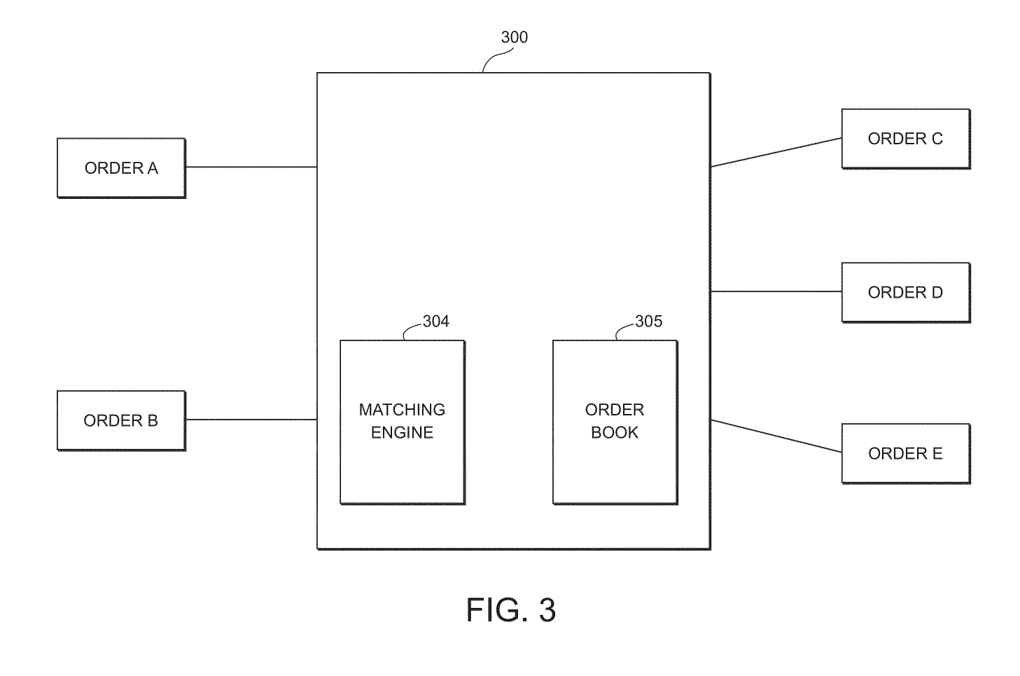

FIG. 3 shows a block diagram of the corporate debt options exchange 300 receiving multiple orders from different broker systems 100. In the example shown in FIG. 3, orders A-E are submitted to the corporate debt options exchange 300. Orders A-E can be orders to buy/sell both put and call options on corporate debt securities. For example, order A can be an order to buy a call option on $10,000 face value of IBM bonds at $5.00 per $100 face value. Order B can be an order to sell a call option on $10,000 face value of IBM bonds at $6.00 per $100 face value. Order C can be an order to buy a put option on $7,500 face value of IBM bonds at $0.75 per $100 face value. Order D can be an order to sell a put option on $10,000 face value of IBM bonds at $0.95 per $100 face value. Order E can be an order to sell a call option for $50,000 face value of Apple Notes at $3.75 per $100 face value.

The exchange 300 accepts the orders A-E, and the matching engine 304 attempts to match the orders with orders in the order book 305. In an example embodiment, if the exchange 300 cannot match a particular order, the order is stored in the order book 305 so that it may be potentially matched against a future order. It should be appreciated that multiple order books may be associated with multiple companies and/or options on the underlying bonds. So in the example above, order E may be directed to a different order book than orders A-D.

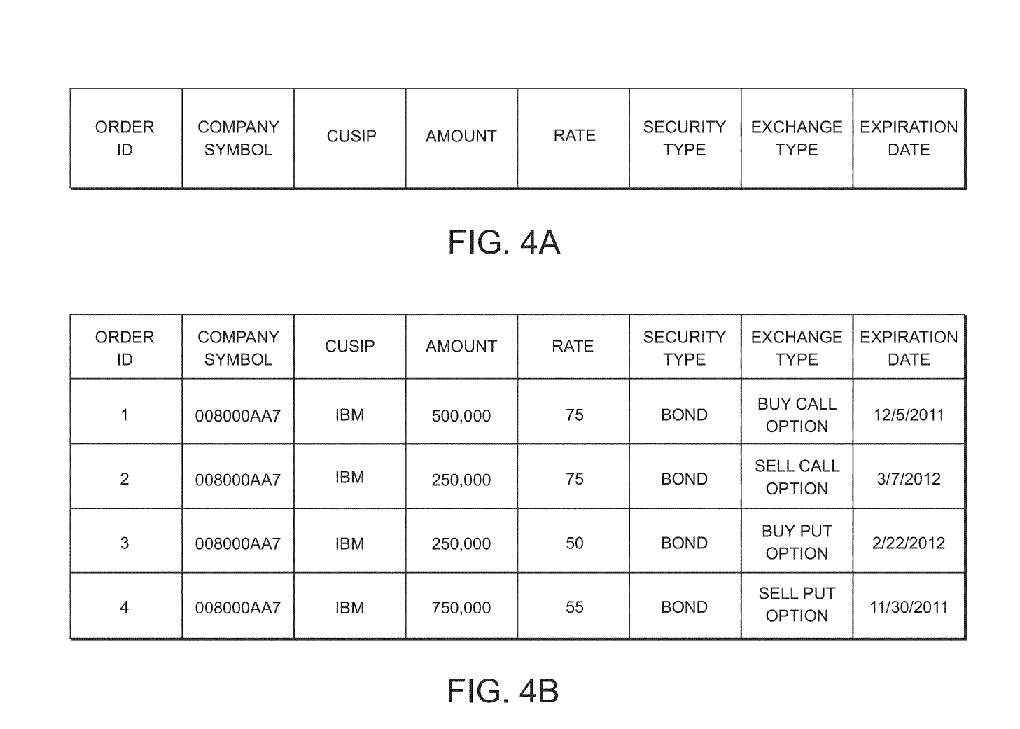

FIGS. 4A and 4B show an example, non-limiting data structure of an order for a corporate debt option and an example of entries in the order book for corporate debt options, respectively. In FIG. 4A, an example order can have some form of order identifier (OID). As discussed above, an example order can be an order to buy a call option on $10,000 face value of IBM bonds at $5.00 per $100 face value. The order also includes an identifier for the company in which to purchase the particular bond (e.g., a company symbol), a CUSIP (Committee on Uniform Security Identification Procedures) number associated with the bond, an amount in which to acquire a particular bond, a rate (e.g., percentage, cents on the dollar, etc.), an exchange type (e.g., buy call option, sell call option, buy put option, sell put option, etc.), and an expiration date for the order.

It should be appreciated that there are several ways to identify a particular company and/or the corporate debt securities being exchanged, and the identifier for the debt securities is not limited to a CUSIP number. It should also be appreciated that the corporate debt security is not limited to bonds and could be, notes or short term obligation securities, for example.

FIG. 4B shows an example of entries in an order book. As can be seen in FIG. 4B, four entries are shown with OIDs of 1 to 4, respectively. The first order is a buy call option type order for $500,000 face value of IBM bonds at $0.75 per $100 face value expiring on Dec. 5, 2011. As can be seen in FIG. 4B, the order is associated with the company symbol (i.e. IBM) and the associated CUSIP (i.e. 008000AA7). The second order (i.e. OID 2) shows sell call option type order for $250,000 face value of IBM bonds at $0.75 per $100 face value and expiring on Mar. 7, 2012. In this example, the second order could match with at least part of the first order for $250,000 face value of IBM bonds (provided that neither order has expired).

The third order is for a buy put option on $250,000 face value of IBM bonds at $0.50 per $100 face value and expiring on Feb. 22, 2012. Finally, the fourth order is for sell put option on $750,000 face value of IBM bonds at $0.55 per $100 face value and expiring on Nov. 30, 2011. In this example, the order book holds entries for orders on corporate debt securities for a single CUSIP and a single company. But, the exchange can be designed so that an order book may take orders for multiple CUSIPs for a single company or for multiple CUSIPs for multiple companies.

As explained above, the corporate debt options exchange 300 attempts to match incoming orders via the matching engine 304 with the orders currently stored in the order book 305. If the orders cannot be matched, either full or partial orders can be stored in the order book 305 to be matched against a future order.

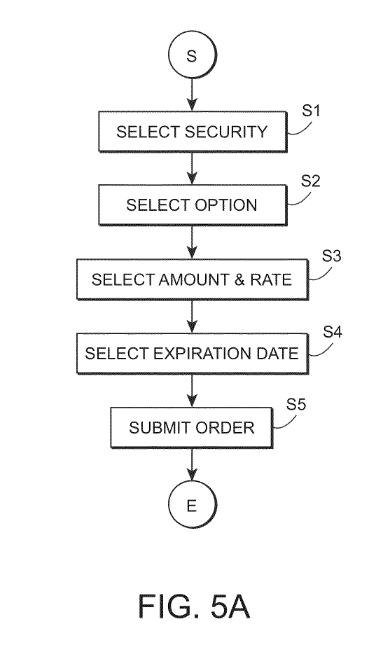

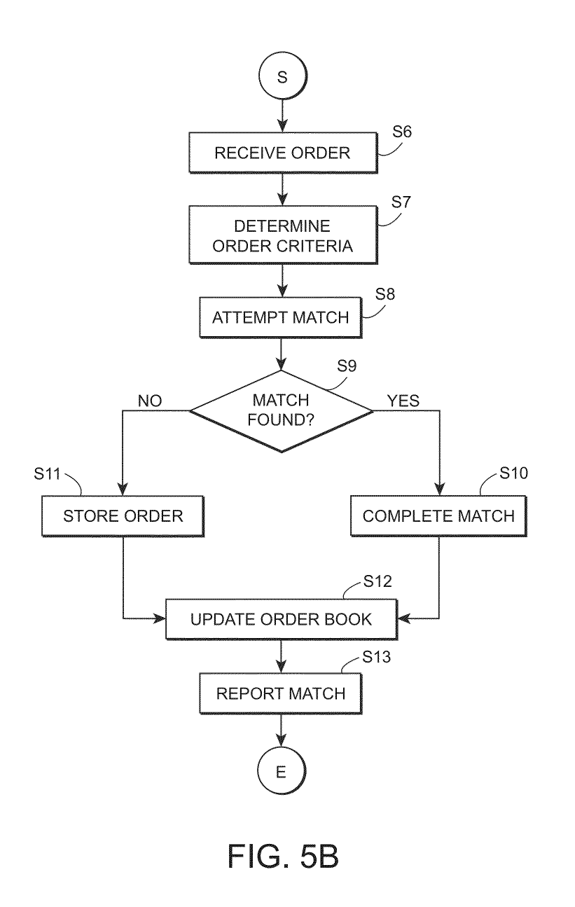

FIG. 5A shows an example embodiment of a flowchart for the electronic corporate debt options exchange. The steps may be implemented based on computer program instructions stored in a memory and executed by one or more computers.

The process begins in step S1 where a corporate debt security to purchase/sell an option on the corporate debt security can be selected. For example, buying IBM bonds or Apple notes.

In step S2, the particular option type for the option on corporate debt security can be selected. For example, a user can select to buy a put option on a corporate debt security or a call option on a corporate debt security.

In step S3, a price and rate for the purchase/sale of the option on the corporate debt security can be set. For example, a user may desire to purchase an option at a given rate.

After selecting the securities, the option type, the rate, and the amount for the option, the process proceeds to step S4 where an expiration date for a particular order can be determined. For example, it may be advantageous to put an order in for an option on a bond and set an expiration date in the event that the bond may increase in value (i.e. in the case of a sale) or decrease in value (i.e. in the case of a purchase). That way, the order can expire to the user's benefit so that the user may not complete an order that could be financially detrimental to them.

After setting the options in steps S1-S4, the process proceeds to step S5 where the order will be submitted to the corporate debt options exchange 300. As described below, the exchange 300 will attempt to match the order.

FIG. 5B shows a flowchart of example operations performed by the electronic corporate debt options exchange 300 after order submission. The steps may be implemented based on computer program instructions stored in a memory and executed by one or more computers.

In step S6, the exchange 300 receives the order from the broker system 100, for example. Upon receiving the order, the exchange 300 determines the various conditions involved in the order in step S7. For example, the system determines the security type for the order (e.g., note or bond), the expiration date for the order, the exchange type (e.g., buy call option, sell put option), the amount, and/or rate.

After determining the various criteria for the order, the process proceeds to step S8 where the exchange attempts to match the order with a stored order in the order book. In step S9, the exchange determines if a match is found. The order successfully matches if the criteria set in the order are satisfied by the stored order in the order book (step S10). If a match is not found, the order is stored in the order book (step S11), and the order book is updated (step S12).

After completing the order process and updating the order book, the exchange 300 can electronically report the status of the order to a broker system 100. So, if the order has matched, the corporate debt options exchange 300 will report the order completion to the broker system 100, and likewise, if the order did not match, the corporate debt options exchange 300 will report that the order is now stored in the order book 305.

While the technology has been described in connection with example embodiments, it is to be understood that the claims are not limited to the disclosed embodiments, but on the contrary, are intended to cover various modifications and equivalent arrangements.

1. An order processing method for matching orders for corporate debt options in an electronic corporate debt options exchange, the corporate debt options exchange having one or more processors, the method comprising:
receiving, by a communications interface of the corporate debt options exchange, an order message for a Trade Reporting And Compliance Engine (TRACE) eligible corporate debt option;
determining, by a processor of the corporate debt options exchange, one or more conditions for purchase/sale on an order comprised in said order message for the TRACE-eligible corporate debt option;
determining, by the processor of the corporate debt options exchange, if the order for the TRACE-eligible corporate debt option matches with a stored order in an electronic order book in the corporate debt options exchange based on the one or more determined conditions;
storing, by a non-volatile memory, an electronic copy of the order in the electronic order book if no match for the order is found; and
issuing, by the communications interface of the corporate debt options exchange, an electronic TRACE report message for subsequent dissemination to an Options Price Reporting Authority,
wherein the TRACE-eligible corporate debt option is an option on a TRACE-eligible corporate debt security, the option allowing the TRACE-eligible corporate debt security to be traded at a predetermined price on or before a predetermined expiration date.

2. The order processing method of claim 1, wherein the corporate debt options exchange is a centralized, automated electronic exchange in a corporate debt options exchange system.

3. The order processing method of claim 1, wherein the one or more conditions for the order for the corporate debt option comprises:
selecting, by the processor of the corporate debt options exchange, an amount of the TRACE-eligible corporate debt options to purchase/sell;
selecting, by the processor of the corporate debt options exchange, a price to purchase/sell the option on the TRACE-eligible corporate debt security;
selecting, by the processor of the corporate debt options exchange, an expiration date for the TRACE-eligible corporate debt option;
selecting, by the processor of the corporate debt options exchange, a put option for the TRACE-eligible corporate debt option;
selecting, by the processor of the corporate debt options exchange, a call option for the TRACE-eligible corporate debt option; and
selecting, by the processor of the corporate debt options exchange, a combination of two or more put or call combinations.

4. The order processing method of claim 3, wherein the order is a quote for a TRACE-eligible corporate debt option.

5. The order processing method of claim 3, wherein selecting the put option allows a buyer of the option on the TRACE-eligible corporate debt security to require a seller of the option to buy the TRACE-eligible corporate debt security if exercised after the expiration date.

6. The order processing method of claim 3, wherein selecting the call option allows a buyer of the option on the TRACE-eligible corporate debt security to require a seller of the option to sell the TRACE-eligible corporate debt security if exercised after the expiration date.

7. The order processing method of claim 3, wherein the TRACE-eligible corporate debt option is an option on a corporate bond.

8. The order processing method of claim 3, wherein the TRACE-eligible corporate debt option is an option on a corporate note.

9. A non-transitory computer-readable storage medium having computer readable code embodied therein and capable of being stored in a memory as computer program instructions, which when executed by a computer having one or more processors, performs functionality comprising:
receiving an order for a TRACE-eligible corporate debt option determining one or more conditions for purchase/sale on the order for the TRACE-eligible corporate debt option;
determining if the order for the TRACE-eligible corporate debt option matches with a stored order in an order book in the corporate debt options exchange based on the one or more determined conditions; and
storing the order in the order book if no match for the order is found, wherein the TRACE-eligible corporate debt option is an option on a TRACE-eligible corporate debt security, the option allowing the TRACE-eligible corporate debt security to be traded at a predetermined price on or before a predetermined expiration date.

10. A corporate debt option exchange apparatus, comprising:
a memory configured to store orders for TRACE-eligible corporate debt options in an order book; and
one or more processors, coupled to the memory, configured to match orders for TRACE-eligible corporate debt options in the corporate debt options exchange apparatus and configured to:
receive an order for a TRACE-eligible corporate debt option;
determine one or more conditions for purchase/sale on the order for the TRACE-eligible corporate debt option;
determine if the order for the TRACE-eligible corporate debt option matches with a stored order in the order book in the corporate debt exchange apparatus based on the one or more determined conditions; and
store the order in the order book if no match for the order is found,
wherein the TRACE-eligible corporate debt option is an option on a TRACE-eligible corporate debt security, the option allowing the TRACE-eligible corporate debt security to be purchased/sold at a predetermined price on or before a predetermined expiration date.

11. The corporate debt option exchange apparatus of claim 10, wherein the corporate debt options exchange apparatus is a centralized, automated electronic exchange in a corporate debt options exchange system.

12. The corporate debt option exchange apparatus of claim 10, wherein the one or more conditions for the order for the TRACE-eligible corporate debt option comprises:
selecting an amount of TRACE-eligible corporate debt options to purchase/sell;
selecting a price to purchase/sell the option on the TRACE-eligible corporate debt security;
selecting an expiration date for the TRACE-eligible corporate debt option;
selecting a put option for the TRACE-eligible corporate debt option;
selecting a call option for the TRACE-eligible corporate debt option; and
selecting a combination of two or more put and/or call combinations.

13. The corporate debt option exchange apparatus of claim 12, wherein the order is a quote for a TRACE-eligible corporate debt option.

14. The corporate debt option exchange apparatus of claim 12, wherein selecting the put option allows a buyer of the option on the TRACE-eligible corporate debt security to require a seller of the option to buy the TRACE-eligible corporate debt security if exercised after the expiration date.

15. The corporate debt option exchange apparatus of claim 12, wherein selecting the call option allows a buyer of the option on the TRACE-eligible corporate debt security to require a seller of the option to sell the TRACE-eligible corporate debt security if exercised after the expiration date.

16. A corporate debt option exchange system, comprising:
a broker apparatus having:
one or more processors configured to create orders;
a memory, coupled to the one or more processors, configured to store the created orders, and
a first data transceiver device for transmitting the created orders; and
a corporate debt option exchange apparatus having:
a memory configured to store orders for TRACE-eligible corporate debt options in an order book,
a second data transceiver device for receiving the created orders, and
one or more processors, coupled to the memory, configured to match orders for TRACE-eligible corporate debt options in the corporate debt option exchange apparatus and configured to:
receive an order for a TRACE-eligible corporate debt option;
determine one or more conditions for purchase/sale on the order for the TRACE-eligible corporate debt option;
determine if the order for the TRACE-eligible corporate debt option matches with a stored order in the order book in the corporate debt exchange apparatus based on the one or more determined conditions; and
store the order in the order book if no match for the order is found,
wherein the TRACE-eligible corporate debt option is an option on a TRACE-eligible corporate debt security, the option allowing the TRACE-eligible corporate debt security to be purchased/sold at a predetermined price on or before a predetermined expiration date.

17. The corporate debt option exchange system of claim 16, wherein the corporate debt options exchange apparatus is a centralized, automated electronic exchange in the corporate debt options exchange system.

18. The corporate debt option exchange system of claim 16, wherein the one or more conditions for the order for the TRACE-eligible corporate debt option comprises:
selecting an amount of TRACE-eligible corporate debt options to purchase/sell;
selecting a price to purchase/sell the option on the TRACE-eligible corporate debt security;
selecting an expiration date for the TRACE-eligible corporate debt option;
selecting a put option for the TRACE-eligible corporate debt option;
selecting a call option for the TRACE-eligible corporate debt option; and
selecting a combination of two or more put and/or call combinations

19. The corporate debt option exchange system of claim 18, wherein the order is a quote for a TRACE-eligible corporate debt option.

20. The corporate debt option exchange system of claim 18, wherein selecting the put option allows a buyer of the option on the TRACE-eligible corporate debt security to require a seller of the option to buy the TRACE-eligible corporate debt security if exercised after the expiration date, and
wherein selecting the call option allows a buyer of the option on TRACE-eligible the corporate debt security to require a seller of the option to sell the TRACE-eligible corporate debt security if exercised after the expiration date.
